(19) United States
(12) Patent Application Publication
(10) Pub. No.: US 2020/0174755 A1
(43) Pub. Date: Jun. 4, 2020

(54) INTERACTIVE APPLICATION TOOL AND METHODS

(71) Applicant: Lollihop, Inc., New York, NY (US)

(72) Inventors: Maximillian Fritz Rose, New York, NY (US); Michael Edmond Jaoudi, Harrison, NY (US); Suzanne Xie, New York, NY (US)

(73) Assignee: Lollihop, Inc., New York, NY (US)

(21) Appl. No.: 16/206,716

(22) Filed: Nov. 30, 2018

(51) Int. Cl. G06F 8/34; G06F 8/30; G06F 8/35; H04N 21/8545; G06F 9/30

(52) U.S. Cl. CPC G06F 8/34; G06F 8/313; G06F 9/3017; H04N 21/8545; G06F 8/35

(57) ABSTRACT

Interactive application tools, systems and methods are described. A system includes an application tool that enables a user to compose project logic for an application through a user-interface. A memory stores the project logic. The application tool includes one or more user-interface elements that enable a user to identify conditional logic and parameters for events that compose the project logic. In this way, a user can create an application solely through the user-interface without having to write or compile program code.

### CROSS-REFERENCE TO RELATED APPLICATION

This application relates to commonly-assigned application, “Application Development Preview Tool and Methods,” (Atty. Dkt. No. 0048.0020000) filed concurrently herewith (incorporated in its entirety herein by reference).

### BACKGROUND

### Technical Field

The present disclosure relates to computer-implemented application development.

### Related Art

Content is used in a variety of applications over computer networks and on computing devices. Audio, video, multimedia, text, interactive games, and other types of content are increasingly accessed by consumers and other users over the Web through browsers. For example, browsers operating on mobile devices allows users to access a range of content on websites and web applications. Mobile devices also have mobile applications that allow users to access content on their mobile devices streamed or downloaded to the mobile devices over networks.

Creating content has become increasingly important. However, content creators face a limited set of options to create content. This has resulted in a creation workflow that is inefficient and inaccessible. For example, the creation workflow in the past has been divided into three separate stages with multi-step handoffs: creation, prototyping and production. Development tools have been provided but they are often limited. Certain tools may require coding or can only be used by professionals at a particular stage of the creation workflow. This is especially burdensome or prohibitive in application development, such as, games and other interactive content.

For instance, a tool, such as, an Adobe Photoshop or Sketch tool, can provide extensive options for creating content but only operates at the creation stage to output content files. Additional work and programming expertise is required to extend the content files to generate a prototype and produce code for an interactive application using the output content files. Similarly, prototyping tools, such as, Invision or Principle, may be used but these too only assist with a prototype stage. Additional work and programming expertise is required to create content and to produce code for an interactive application. Finally, developer tools like an integrated developer environment (IDE), such as an Xcode or Unity tool, can be used to generate code for applications ready to submit to an application store. These developer tools though require programming and are prohibitive for most content creators.

Traditional developer tools and IDEs, such as Xcode or Unity, produce code that requires compilation to be packaged and delivered to the destination devices, allowing for runtime behavior when executed. Each platform, operating system and device hardware setup that the application will be distributed to requires its own compilation. This adds complexity to the delivery of content, which is cumbersome to the creators of content and developers of applications.

What is needed is a tool that allows content creators to create content and produce interactive applications without programming knowledge and writing code. A tool is needed that can simplify the creation workflow and make content creation accessible for a wide range of creators with different skill levels and experience.

### BRIEF SUMMARY

New interactive tools, systems, computer-readable devices and methods to create applications are described. A tool is provided that allows creators to make interactive, native mobile content.

In an embodiment, a system includes an application tool that enables a user to compose project logic for an application through a user-interface. A memory is configured to store the project logic. The application tool includes one or more user-interface elements that enable a user to identify conditional logic and parameters for events that compose the project logic.

In another embodiment, a computer-implemented method includes steps enabling a user to compose project logic for an application through a user-interface including displaying one or more user-interface elements that enable a user to identify conditional logic and parameters for events that compose the project logic; and storing the project logic in computer-readable memory.

In one advantage, a user can create an application through a user-interface without having to write program code.

Additionally, the methods described allow the defined logic and behavior to be highly portable. The memory allotment for the defined logic can be shared between devices with access to a configured reading client without the need to perform platform specific compilation, allowing logic and behavior to be added to the runtime of an executing application.

A number of further features are also described. In one feature, an application includes interactive media and the one or more user-interface elements enable a user to identify conditional logic and parameters for events that involve the interactive media. In another feature, parameters for events include trigger parameters that define state information and effects for one or more events. The state information includes the requisite states indicative of when a response for particular event is to be triggered at runtime of the application. The effects includes information that identifies operations or instructions to be performed for the particular event during runtime of the application. In one example, an effect comprises a reference to a separately defined action or comprises one or more values that define an action to be carried out during runtime of the application.

In a further embodiment, stored project logic includes a plurality of nested models that define one or more scenes of interactive media content for an application. In a feature, the nested models include a set of default models modified to define the one or more scenes of interactive media content. In one example, each scene model includes a reference to one or more of the following models: Layer, Interaction, Action, Effect, Conditional Case, Condition, Reference, Animation Component, Variable, Value, or Value Equation.

In a still further embodiment, stored project logic includes a plurality of nested models, each nested model being a self-archiving model. In a feature, each self-archiving model identifies its own respective archiving and unarchiving characteristic.

In a still further embodiment, the application tool includes an editor. The editor is configured to control edits to project logic composed for an application. In one feature, the editor is configured to output an editor window for display. The editor window includes at least one of a control region, canvas region, or scene events region.

In a further feature, the one or more user-interface elements include model display elements that can allow a user to identify interactions or effects. In one embodiment, An editor is configured to initialize an interaction model corresponding to an identified interaction and output for display in the canvas region one or more model display elements having one or more selectable triggers for the identified interaction. In this way, a user developing an application can add the interaction to a workflow of the application through selections made in the canvas region with respect to the one or more model display elements without having to write program code. The editor is further configured to update the interaction model to represent selected triggers for the identified interaction.

In a further feature, the identified interaction includes one or more effects that may be conditionally associated with the identified interaction. The editor is configured to output for display in the canvas region one or more model display elements having one or more selectable parameters for an effect for the identified interaction. The editor is also configured to update an effect model to represent a selected parameter for an effect conditionally associated with the identified interaction, and update the interaction model to represent the selected effect.

In additional embodiments, the application tool may also include a previewer or publisher.

Further embodiments, features, and advantages of the invention, as well as the structure and operation of the various embodiments of the invention are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a diagram of a computing device having an application tool in accordance with an embodiment.

FIG. 2 is a diagram of a nested model hierarchy capable of storing project logic in accordance with an embodiment.

FIG. 3 is a diagram showing an editor of FIG. 1 in further detail in accordance with an embodiment.

FIG. 4 is a diagram showing in further detail a project logic processor in accordance with an embodiment.

FIG. 5 is a diagram of a computing device that can be used to implement an application tool in accordance with an embodiment.

FIGS. 6A-6D is a flowchart diagram of application tool operations and methods in accordance with an embodiment.

FIG. 7 is a screenshot diagram of an example application with interactive elements created with an application tool and method in accordance with an embodiment.

FIG. 8 is a diagram of example project logic for a project including a concert story defined with a nested model hierarchy in accordance with an embodiment.

FIG. 9 is a diagram illustrating a factory operation to generate a runtime loading context from a stored model for a preview in accordance with an embodiment.

FIG. 10A is a block diagram of a canvas controller and a graphical representation of a logical relationship between example runtime objects. FIG. 10B is a block diagram of a canvas controller and a graphical representation of runtime objects mounted from a loading context for a concert example.

FIG. 11 is a flowchart diagram of a publishing operation to publish application store ready code of FIG. 1 in accordance with an embodiment.

### DETAILED DESCRIPTION

New interactive tools, systems and methods to create applications are described. Embodiments include computer-implemented application development tools including application creation, behavior storage, previewing and/or publishing.

Embodiments refer to illustrations described herein with reference to particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Application Development Without Programming

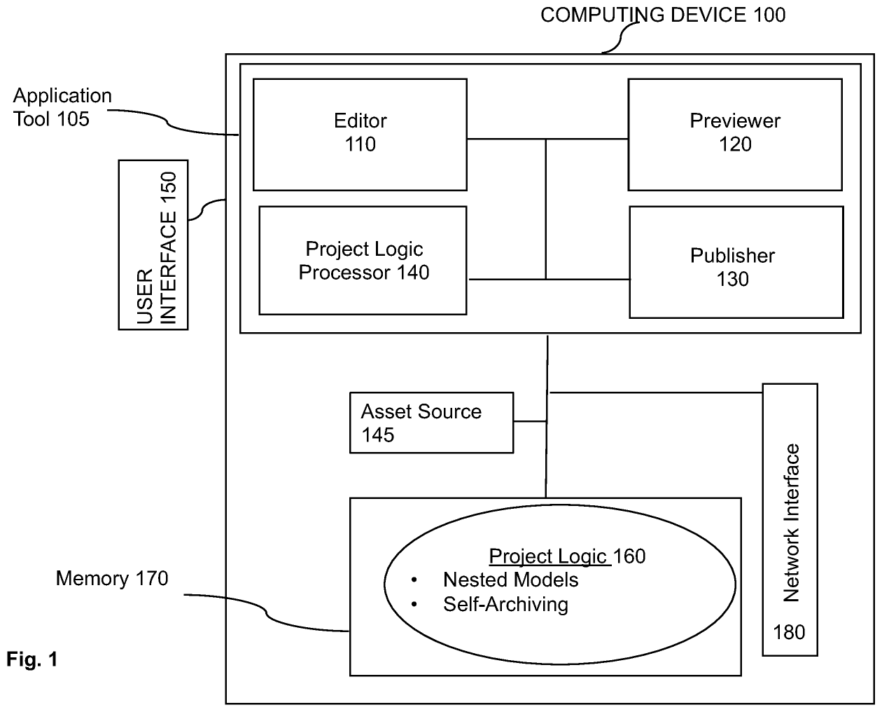

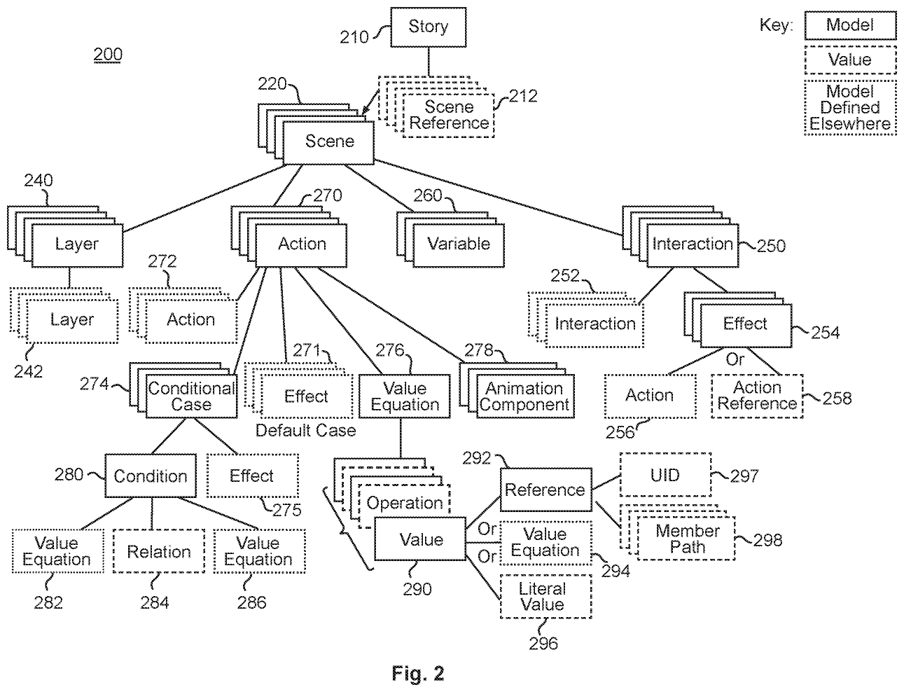

FIG. 1 shows a computing device 100 having an application tool 105 and project logic 160 in accordance with an embodiment. Application tool 105 includes editor 110, previewer 120 and publisher 130. Application tool 105 may further include project logic processor 140. Project logic processor 140 is coupled to an asset source 145. Project logic processor 130 is also coupled to editor 110, previewer 120 and/or publisher 140. Project logic 160 can be stored in a computer-readable memory 170.

In a feature, application tool 105 enables a user to compose project logic 160 for an application through a user-interface 150. Application tool 105 outputs one or more user-interface elements for display on user-interface 150. The one or more user-interface elements may enable a user to identify conditional logic and parameters for events that compose project logic 160. In this way, a user of application tool 105 can create an application solely through user-interface 150 without having to write program code.

In some examples, application tool 105 may allow a user to compose project logic 160 for an application having interactive media (such as, an application having a story, game, animation, or other use of digital media content). The one or more user-interface elements enable the user to identify conditional logic and parameters for events in the application.

In an embodiment, project logic 160 contains data defining the behavior for a project stored in a nested model hierarchical structure. The data for a project can include interactive media. The interactive media can be digital media making up a story, game, animation, or other digital media content. A nested model structure may include models logically arranged in a hierarchy such as a tree hierarchy. The model hierarchy may include data representative of discrete navigable elements, such as scenes, screens or pages, and objects contained therein. In a feature, data regarding interactions and effects are included. Trigger parameters may define state information and effects for one or more events. The state information includes the requisite states indicative of when a response for particular event is to be triggered. The effects may be information that identifies operations or instructions to be performed for the particular event. For example, an effect may be a reference to a separately defined action or may be one or more values that define an action. An action may store the values necessary to perform runtime behavior.

In one feature not intended to be limiting, the project logic 160 uses nested models to define an application. For example, an application having interactive media may convey a story made up of multiple scenes defined with nested models. The nested models include a set of user-created or default models to define the story. Scene models may include one or more of the following models: Layer, Interaction, Action, Effect, Conditional Case, Condition, Reference, Animation Component, Variable, Value, or Value Equation.

In a further feature, the stored project logic 160 may be a plurality of nested models, each nested model being a self-archiving model. Each self-archiving model identifies its own respective archiving and unarchiving characteristic.

In an embodiment, editor 110 controls edits to project logic 160 composed for an application. Previewer 120 processes project logic 160 composed for an application to obtain runtime objects that enable a user to view and interact with the application as in runtime. Publisher 130 automatically publishes application store ready code including files based on project logic 160 composed for an application. For example, publisher 130 may store the model information necessary to define runtime objects into application store ready code.

Memory 170 can be one or more memory devices for storing data locally or remotely over a network. A network interface 180 may be included to allow computing device 100, including application tool 105 and its components, to carry out data communication over one or more computer networks such as a peer-to-peer network, local area network, medium area network, or wide area network such as the Internet.

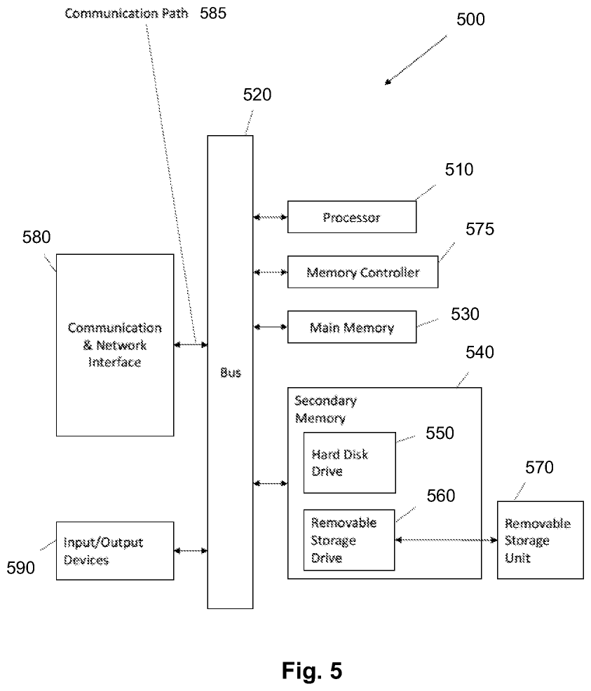

In embodiments, computing device 100 can be any electronic computing device that can support user-interface 150 and application tool 105. A user can enter control inputs to application tool 105 through user interface 150. For example, computing device 100 can include, but is not limited to, a desktop computer, laptop computer, set-top box, smart television, smart display screen, kiosk, a mobile computing device (such as a smartphone or tablet computer), or other type of computing device having at least one processor and memory. In addition to at least one processor and memory, such a computing device may include software, firmware, hardware, or a combination thereof. Software may include one or more applications and an operating system. Hardware can include, but is not limited to, a processor, memory and user interface display or other input/output device. An example computing device, not intended to be limiting, is described in further detailed below with respect to FIG. 5.

User-interface 150 may be graphical user-interface, such as, a keyboard, microphone, display and/or touchscreen display coupled to computing device 100. User-interface 150 may include any one or more display units (such as a monitor, touchscreen, smart board, projector or other display screen) that provides visual, audio, tactile and/or other sensory display to accommodate different types of objects as desired. A display area (also called a canvas) can be any region or more than one region within a display. User-interface 150 can include a single display unit or can be multiple display units coupled to computing device 100.

Computing device 100 may also include a browser. For example, a browser can be any browser that allows a user to retrieve, present and/or traverse information, such as objects (also called information resources), on the World Wide Web. For example, an object or information resource may be identified by a Uniform Resource Identifier (URI) or Uniform Resource Locator (URL) that may be a web page, text, image, video, audio or other piece of content. Hyperlinks can be present in information resources to allow users to easily navigate their browsers to related resources. Navigation or other control buttons can also be provided to allow a user to further control viewing or manipulation of resources. In embodiments, a browser can be a commercially available web browser, such as, a CHROME browser available from Google Inc., an EDGE browser (or Internet Explorer) browser available from Microsoft Inc., a SAFARI browser available from Apple Inc., or other type of browser.

Model Hierarchy with Self-Archiving Nested Models

FIG. 2 is a diagram of example project logic 200 defined with a model hierarchy in accordance with an embodiment. In one feature, project logic 200 is made up of a plurality of nested models. Project logic 200 defines a story 210 having multiple scene models 220 arranged a hierarchy. Story 210 for example may reference (or link to) multiple scene references 212 making up the story 210 in for an application being developed. Scene references 212 can each reference respective scene models 220. Each scene model 220 is further defined with nested models and/or values arranged in nodes of a tree hierarchy. Each scene model 220 may include references to one or more of the following models: Layer, Interaction, Action, Effect, Conditional Case, Condition, Reference, Animation Component, Variable, Value, or Value Equation.

Nested models may be stored locally or accessed remotely. Nested models may include one or more of default models previously defined and/or models created by a user or other users. A user can further modify a default model or user-created model as desired to define a story. A nested model in a hierarchy may be data making up the model itself or a value. Value may be a data value or can be a reference (such as an address, or other unique object identifier) referencing the data making up the model.

In the example hierarchy of models shown in FIG. 2, a scene model 220 is a root (top level) of a tree hierarchy. A tree hierarchy is a data structure made up of nodes at different levels that logically branch from a root down to one or more lower levels. A node at the end of a branch may also be called a leaf. Nodes in a higher level are also referred to as parent nodes while the nodes they logically connect to in a lower level are referred to as child nodes. As shown in the key for FIG. 2, a node in a level may be made up of a model, value or a reference.

Each node in the tree hierarchy can separated as a root of its own nested hierarchy that can be archived, un-archived, converted to runtime or transferred as a distinct unit of data either as stand-alone information or into another nested model hierarchy.

Scene model 220 includes references (also called links) that branch to a set of one or more Layer models 240, Interaction models 250, Variable models 260, and/or Action models 270 arranged a different level of a tree hierarchy below scene model 220. Layer model 240 may link to or contain additional Layer models 242. Interaction model 250 may link to or contain Interaction models 252. Action model 270 may also contain Action models 272.

In many applications, a user will want to create events that require conditional logic, effects, trigger events or animations. This can be captured in scene model 220 as part of story 210. For example, Interaction model 250 includes links to Effect model 254. Effect model 254 links Action model 256 or a reference to an action 258. Action model 270 includes links to a level that includes Effect model 271, Conditional Case model 274, Value Equation model 276 and Animation Component model 278. Conditional Case model 274 in turn links to a Condition model 280 and Effect model 275. Conditional model 280 further links to a level having Value Equation model 282, relation value 284, and Value Equation model 286. Value equation model 276 links to a set of one or more values defining operations and/or Value models 290. Value model 290 further links to a Reference model 292, or Value Equation model 294, or literal value 296. Reference model 292 further links to a unique identifier (UID) value 297 and member path value 298.

In project logic 200, models may be objects that can be referenced. Referenceable objects include:
Layers, a model defining visual content
Actions, a model defining discrete behavior
Interactions, a model defining dynamic behavior
Variables, value containers

Each model that can be referenced includes a unique identifier, or “symbol.” Any reference to another object in the model space contains the symbol for that object and optionally a member path. Each object type represented by a model has a collection of accessible parameters. A member path describes which parameter is accessed by a reference.

Example member paths are:
Layer position
Layer opacity
Layer scale
Layer rotation
Layer text
Animation duration
Vector x
Vector y
Vector width
Vector height

An example combination could be:
Layer position, Vector X

A value equation is a linked list of references or literal values and operations (ref/lit→op→ref/lit→op→ref/lit . . . ). Like other references, these can be just a symbol or include a member path.

Some example equations are:
Layer 1's position, vector x+20−Animations 1's duration*4
Layer 2's rotation+pi
Layer 3

A variable is a model that represents some value that can be changed when the logic is run, so it has no intrinsic value. When referenced, it is used as a placeholder for the value it will have when the logic is run. When set, it is a reference to the runtime container that will store the value defined.

Trigger parameters are the values that control the state under which an event listener will perform its effects. For example, trigger parameters may include, but not limited to:
Type (touch, press, swipe, drag, action state changed, navigation state changed, device moved)
Triggering reference: a symbol to the triggering layer or action
Destination reference: a symbol for a layer to be dragged to
Duration: for press length
Direction: for swipe movement, or device tilting
Playback state: for action state changes
Navigation state: for navigation state changes
Continuous state: for touch begin, end, or moved
Magnitude: for swipe speed, or device movement speed

An Effect model can either be a reference to a separately defined action, or contain values that are able to define an action. An Action model stores the values necessary to perform runtime behavior. This includes, but is not limited to:
Animation time details and keyframe details
Audio paths and phoneme timings
Wait time
Run state operations (play, pause, stop)
Destinations (URLs, or other internal content via relative reference—next, previous, first, last—or direct reference—scene X, scene Y . . . )
Targets (a list of references to other objects in the project)
A value equation (more details below)
Collection of other actions and/or action references
Specifications for how to perform contained actions/referenced actions
A collection of condition-ordered effects pairs
A collection of effects defining behavior to perform if all conditions fail—the “default case”.

These examples are illustrative and not intended to be limiting.

Self-Archiving

In a further feature, each nested model is a self-archiving model. Each self-archiving model identifies its own respective archiving and unarchiving characteristic. This self-archiving operation described further below.

As described above, a self-archiving model allows models to be the root of their own nested hierarchy. This allows for individual models and their nested children to be highly portable as discrete units as well as within a larger nested structure.

To archive into and from standardized data formats, each model and member of the model have a conversion defined into either a key-value store, a list of values, a string, or a number, and from one of these general types.

Each model type (Scene, Layer, Interaction, Action, Effect, Conditional Case, Condition, Reference, Animation Component, Variable, Value, and Value Equation) defines their own archiving and unarchiving method (also referred to as their own archiving and unarchiving characteristic or function). This function controls the logic that translates the members of each Model and the Model itself into one of the simplified abstract types—key-value store, list of values, string, or number.

Once translated into the simplified abstract type, the data can be saved to disk, sent over a network, or be handled as any other kind of serialized data—it is no longer language or platform specific. One example implementation may translate this abstract type into a JSON (JavaScript Object Notation) data format.

Both archiving and unarchiving of the Models occur in a recursive pattern, such that archiving a Scene Model archives the Layers, Actions, Interactions, and Variables contained within the Scene Model. Similarly, an archive of an Interaction Model embeds an archive of all of the contained Effect Models, which in turn archives a potentially nested Action Model, which will archive any potentially nested Condition and Effect Models.

Live instances of each Model may have more members than get archived. Data that is not needed to define the current use of the Model is removed to minimize the size of the archive. For instance, an animation Action Model does not utilize Conditional Cases and will not archive any data associated with nested Effects.

Similarly, a file saved to disk can be parsed into live Models either directly or through a recursive call to the nested Model types. Input serialized data will be loaded into memory, and subsequently attempt to initialize a specified Model type with either the whole or part of the loaded data. As with archiving, each Model has a method that defines how to populate its members from the data read from disk. Not every member needs to be contained in the data, and missing data—either intentionally or through corruption—will be filled in with default values, left empty, or fail and throw an exception if essential information is missing or if the data is being decoded into the wrong Model type (i.e. a Layer is trying to be decoded from data archived from an Action).

When loading a Scene Model from disk the JSON will be loaded into memory, and parsed into the simplified abstract types, expecting a key-value store at the root. The Scene Model will then search for keys related to each of the Scene Model's parameters, including: unique identifier, name, coded version, layers, interactions, actions, variables, and template scene. If name or template scene are empty, they are left empty. For the unique identifier or coded version, if one can not be determined a new one will be lazily generated. If the nested Model keys for layers, interactions, actions, or variables, are not contained in the data, the Scene Model's member for that collection will be left empty. If the nested model keys are present, the data contained in that key will attempt to be decoded into the expected Model type. If this nested decoding fails with an exception due to critically malformed data, the Scene Model's decoding will propagate the exception letting the decoding context know of the failure.

Similarly a Layer Model will read its members from the input data, populating members not contained in the input with default values. Nested Layer Models will then be recursively loaded from the input data.

Since each Model defines their own method for unarchiving, and the they implement a recursive call pattern, every Model can be directly initialized by archive data directly. i.e. an Action can be decoded directly from archived Action data from disk, or internally from a nested call when a Scene Model is being decoded, or internally when an Effect Model is being decoded—either directly or from another nested decode call. The same decode method is used to ensure consistency in behavior.

Editor, Previewer, and Publisher

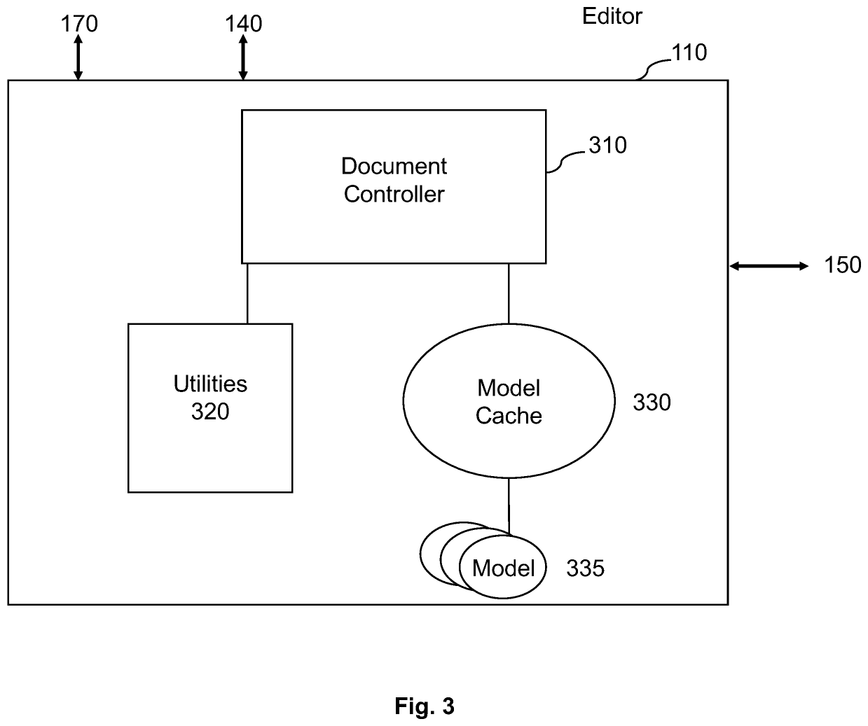

FIG. 3 is a diagram showing an editor 110 of FIG. 1 in further detail in accordance with an embodiment. Editor 110 includes a document controller 310 and utilities 320. A cache 330 stores models 335 being edited. Document controller 310 may be coupled to communicate with each of project logic processor 140, utilities 320, and model cache 330 storing models 335 for editing. Document controller 310 is further coupled to user-interface (UI) 150.

Document controller 310 controls the editing of electronic documents for a user. Each document corresponds to project logic 160 for a project being developed. Document controller 310 may communicate with utilities 320 to allow a user through user-interface 150 to do relevant document operations such as, cut, copy, paste, redo, undo, or validate data. Document controller 310 may interface with project logic processor 140 to obtain project logic for editing models including media assets from asset source 145. Asset source 145 may retrieve or store models and media assets from memory 170, or other local or remote storage devices.

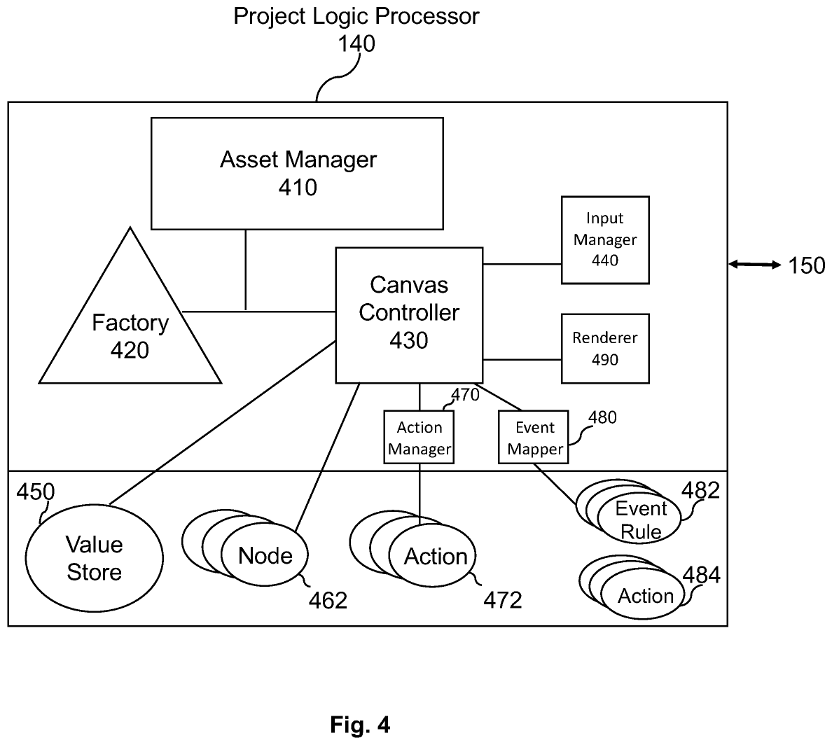

FIG. 4 is a diagram showing project logic processor 140 in further detail in accordance with an embodiment. Project logic processor 140 includes an asset manager 410, factory 420, and canvas controller 430. Project logic processor 140 may also include an input manager 440, action manager 470, event mapper 480, and renderer 490. Factory 420 is used by previewer 120 to generate a loading context with runtime objects and media assets from project logic. In an embodiment, a value store 450, nodes 462, actions 472, event rules 482, and actions 484 (each of which include runtime objects and references to media assets generated by factory 420) may also be stored in memory 170.

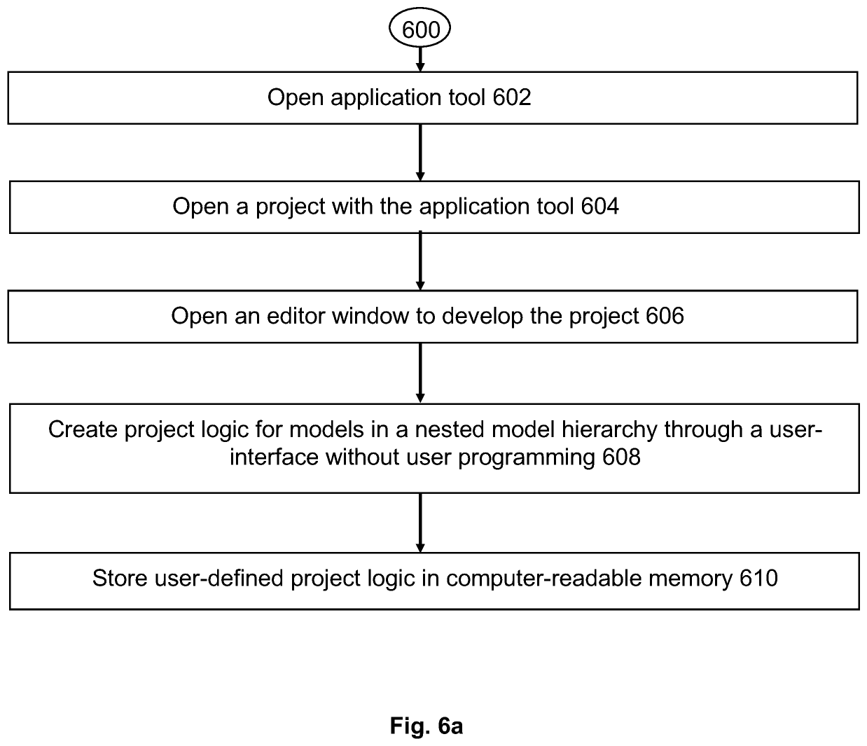

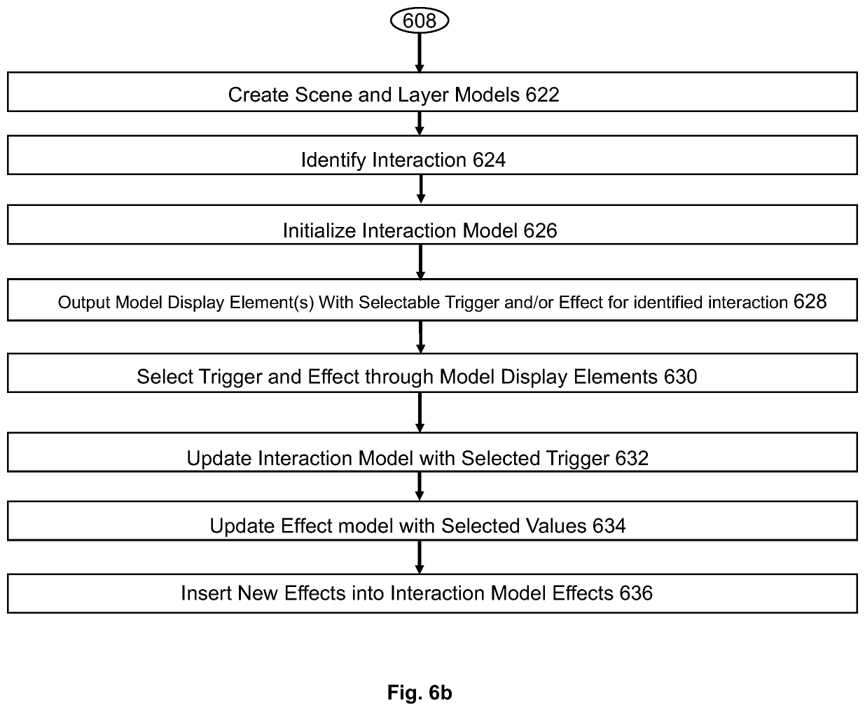

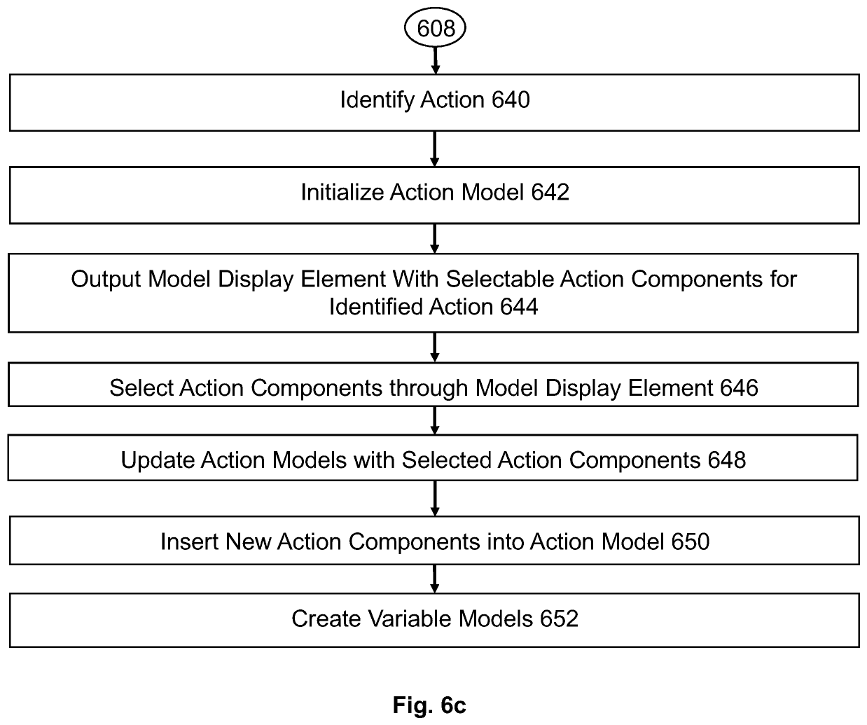

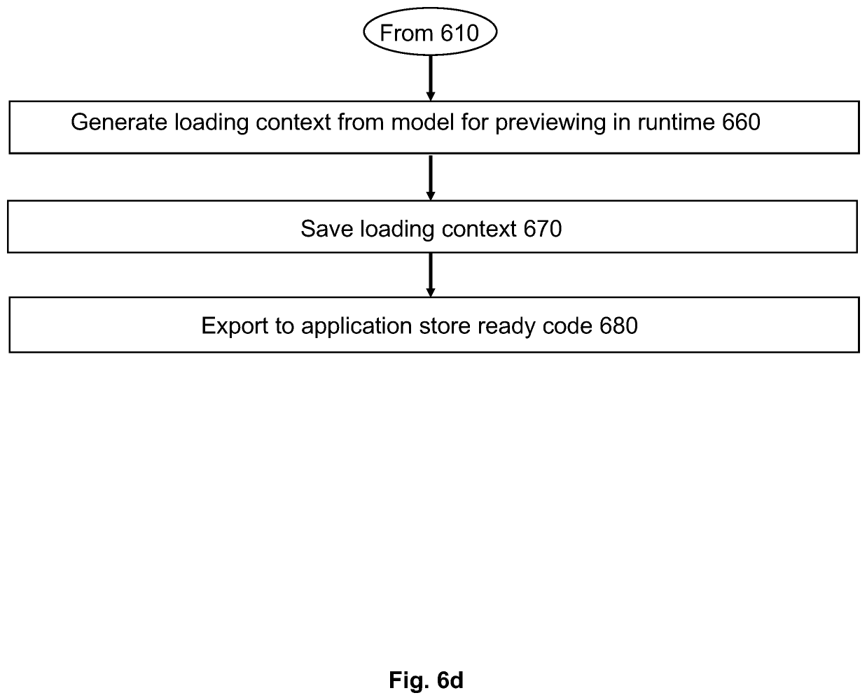

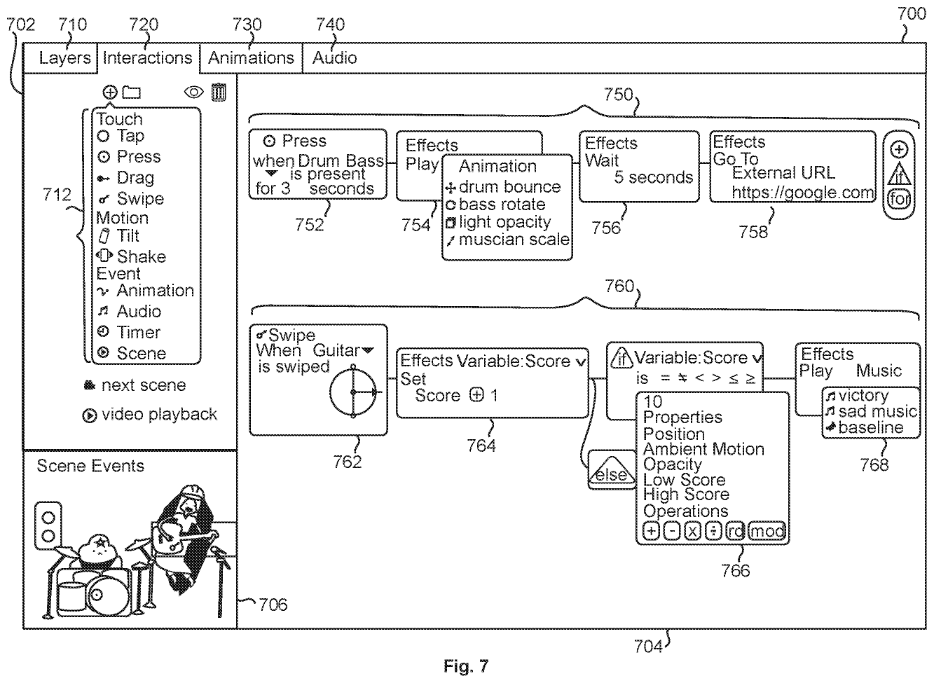

Asset manager 410 is coupled to communicate with asset source 145 and/or with model cache 335. Factory 420 is coupled to asset manager 410 and canvas controller 430. Canvas controller 430 is coupled to each of input manager 440, value store 450, action manager 470, event mapper 480, and renderer 490. Input manager 440 is further coupled to receive inputs from UI 150. Renderer 490 is coupled to a display screen at user-interface 150 to render and draw on the display screen according to outputs from canvas controller 430. The operation of editor 110 and previewer 120 including use of project logic processor 140 is described further with respect to the routine for creating a project in FIG. 6.

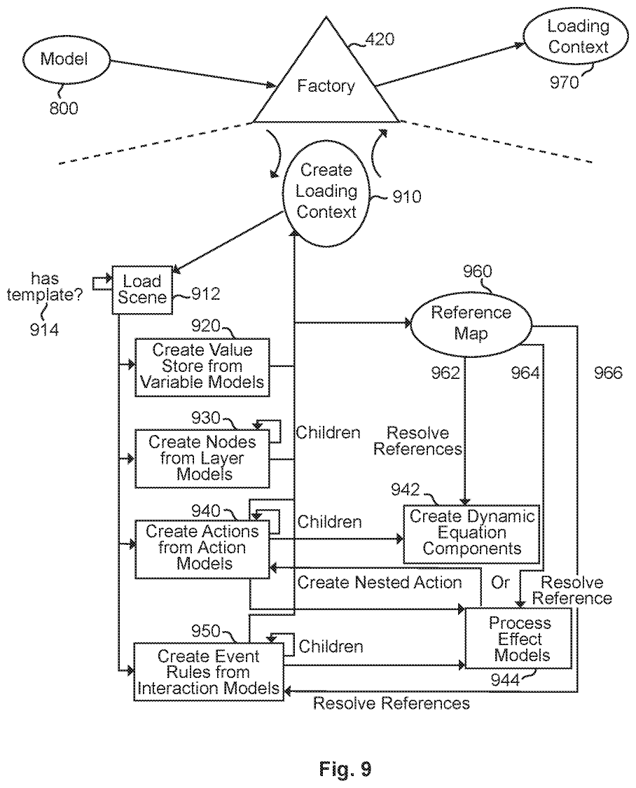

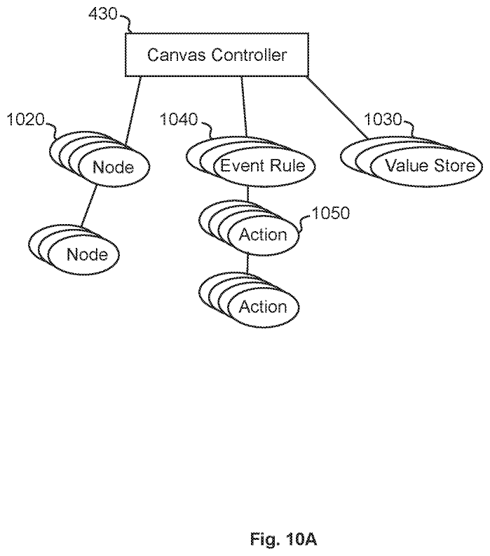

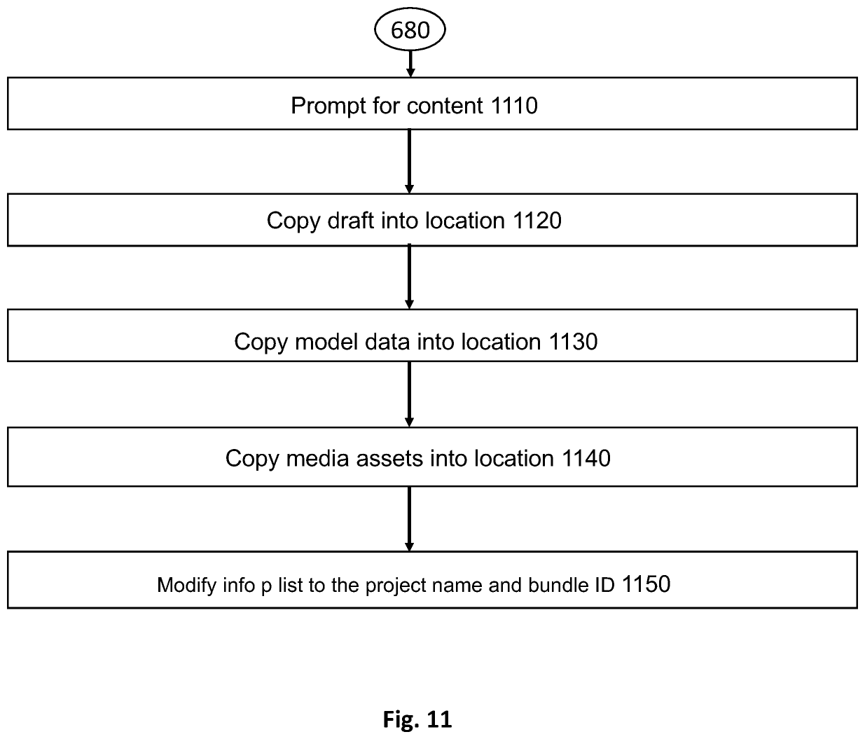

In a further embodiment, previewer 120 is coupled to project logic processor 140 which is coupled to asset source 145. Project logic processor 140 is further coupled to receive inputs from and provide outputs to UI 150. Asset source 145 may receive data from memory 170 and/or network interface 180. The operation of previewer 120 including use of project logic processor 140 is described further with respect to the routine for creating a preview of a project in runtime from models shown in FIG. 9. The operation of publisher 130 is described further with respect to the routine for creating an application store ready program code for a project shown in in FIG. 11.

Application Tool Operation

FIG. 6A-6D are flowchart diagrams of application tool operation and method 600 in accordance with an embodiment (steps 602-680). For brevity, method 600 is described with respect to device embodiments shown in FIGS. 1 and 3-5 but is not necessarily limited to the specific device embodiments. Similarly, method 600 is described with respect to an example concert application shown in FIG. 7 and developed with application tool 105. FIG. 7 shows an example of events relating to a concert scene. The concert scene includes one figure playing a guitar and another figure playing a drum kit having a bass drum, high hat, and cymbals. A user creating a project can identify conditional logic and parameters for events for objects in the scene through a user-interface 150. This can be done by user using graphical user-interface (GUI) elements without the user having to do any programming in a computer readable program language in source code or object code.

In step 602, an application tool 105 is opened. For example, application tool 105 may be opened on computing device 100. Application tool 105 may display an application tool control screen in a window on a display in user-interface 150. The control screen may include a display having one or more user-interface elements, such as tabs, menus, buttons, or other controls.

In step 604, a project is opened. For example, an initial control screen presented by application tool 105 may enable a user to select to open a project. Opening a project may include opening a new project, editing or downloading a previously stored project, or a combination thereof. A user may select a File or Edit tab and in response an editor 110 may generate one or more windows that a user may navigate through to open the project. This may include naming or renaming the project. Editor 110 may further initialize project logic having a nested model hierarchy for the opened project. Previously created models, if any, may be automatically included in the initialized project logic for the opened project. Default models, if any, may be automatically included in the initialized project logic for the opened project. Previously created or default models for the initialized project logic may also be loaded into memory 170 and even a cache (e.g., model cache 335) for faster access by the editor 110.

In step 606, an editor window is opened to develop a project. As used herein to develop a project is meant broadly to include creating or modifying a new project, creating or modifying an existing project, or any other development of a project.

For instance, editor 110 may open an editor window 700 for the opened project. FIG. 7 shows an example window 700 that may be opened by editor 110 and presented for display to a user to develop a project. Window 700 has three regions: control region 702, canvas 704, and scene events region 706. Control region 702 includes controls for defining aspects of a project. This can include four tabs relating to Layers 710, Interactions 720, Animations 730 and Audio 740. Each tab allows a user to input further control commands or values related to actions governed by the tab. When a user selects one of the tabs, further user-interface elements such as pull-down menus may appear. Canvas 704 is a display area where a user can create a project. Model display elements can be displayed in canvas 704. Scene events region 706 is a display area that shows objects and events in a scene relating to a project. In one feature, previewer 120 can output previews for display in scene events region 706.

In a feature, editor 110 through window 700 allows a user to define project logic for models in a nested model hierarchy (step 608). This defining of project logic for models allows identifying of objects, conditional logic and parameters for events and objects that compose scenes in the project. Through user-interface 150, a user can select and navigate controls in control region 702 to identify objects and create events. Editor 110 generates model display elements that further allow a user to identify objects and create events. Parameters relating to events or objects for a project may also be input. A user can also identify conditional logic and parameters for events and interactions between objects in a project. Operation in step 608 is described in further detail below with respect to FIGS. 6B-6C.

In step 610, project logic defined for models developed by a user in step 608 is stored in computer-readable memory 170.

Project Logic Creation for Models in a Nested Model Hierarchy

As shown in FIG. 6B, one or more scene and layer models may be created with editor 110 (step 622). A user can select and navigate controls in control region 702 (such as layers tab 710) to identify a scene. A user may simply name a scene without selecting an image or scene content. Editor 110 then simply creates a default scene model for the new scene. Content is then added to the scene by identifying layers.

In another example, a scene may be identified by a user from viewing or selecting an image. Editor 110 generates a scene model based on the identified scene. The image can be any suitable file format including, but not limited to, a raster or bitmap image file, a JPEG, PNG, GIF file, a scalable vector graphics (SVG) image file, or a video file, such as MP4 or MOV.

Similarly, a user can select and navigate controls in control region 702 (such as layers tab 710) to identify one or more layers. Each layer may correspond to an object in a scene. Properties for an object may also be identified and included in the layer model. These properties may identify how an object in a scene is to be displayed (such as, scale, size, rotational transform, or opacity). Layer tab 710 for example can include controls to allow a user to open a new layer for an object. Objects may be any of the figures, musical instruments, speaker, floor or wall in the scene.

Interactions, Effects and Actions

According to a feature, project logic may further define interaction between objects and events in one or more scenes. Conditional logic and parameters for events and actions involving objects may also be identified. Nested models are used to define these interactions, effects and actions. Further, editor 110 enables a user to define these interactions, effects and actions through user-interface 150. Different model display elements are displayed to enable a user to select desired interactions, effects and actions for a project and to allow a user to identify associated triggers, conditions and values by making selections on the model display elements. In this way, a user can develop an application through user-friendly operations in an editor window through a user-interface without having to perform programming (e.g., writing or editing program code).

In step 624, editor 110 enables a user to identify interactions. An interaction may be an event a user wishes to occur when a user interacts with an application running on a computing device. Interaction tab 720 for example may present a control panel 722 that lists different types of interactions that may be carried out, such as, interactions based on touch, motion or an event occurrence. For example, a user developing an application for running on a mobile computing device, such as a smartphone or tablet with a touchscreen and sensors, may wish to provide a touch interaction (e.g, tap, press, drag or swipe) or motion interaction (e.g., tilt or shake). Example events that a user may wish to incur or add in their application include animation, audio play, setting a timer, or scene change.

Once a user identifies an interaction, editor 110 initializes a corresponding interaction model (step 626). For example, if a user selects a Press interaction in panel 722, editor 110 then initializes a corresponding interaction model for the press interaction.

Depending on the interaction identified, editor 110 outputs one or more model display elements for the identified interaction (step 628). A model display element may include selectable triggers and/or effects for the identified interaction (step 630). For example, as shown in a first branch 750 for a project, a model display element 752 labeled press may be displayed. Model display element 752 includes user-interface elements that allow a user to select which object is affected by the interaction (e.g., Bass Drum) and triggers or effects (e.g., timer for 3 seconds).

Other model display elements 754, 756, and 758 for effects can also be displayed automatically or in response to a user selection in control window 702. In FIG. 7, these effects model display elements 754, 756, 758 can be visually laid out in the same branch 750 as the press interaction model element 752 to visually indicate the logical relationship with the press interaction. A user developing an application and defining the project logic, can enter selections to the Effects model display events to set triggers and parameters for events relating to the effects. For example, effects model display element 754 allows a user to select an animation play effect in response to the drum bass press interaction. A user can also select a type of animation to be played (e.g., drum bounce, bass rotate, light opacity, or musician scale). Effect model display element 756 allows a user to further modify the animation play effect to wait 5 seconds. Effect model display element 758 allows a user to further modify the animation play and wait effects to jump to an external web address (URL) after the wait period. As used in these examples triggers refers to the action of the event triggered (e.g., animation play, wait, or go to). Parameters for events may be the values relating to the event triggered, such as, type of animation, time period, go to link identified, or other parameter.

In step 632, editor 110 updates the Interaction Model with any selected trigger and effects. For example, the Interaction model for a Press (corresponding to model display element 752) is updated to reflect a press of a bass drum for 3 seconds (trigger). In step 634, editor 110 updates one or more effect models with values based on user selections for effects. In FIG. 7, these values may be the type of animation (bass rotate), wait time period (5 seconds), and go to external link (www.google.com). In step 636, editor 110 inserts new selected effects into effects stored in the Interaction Model.

As shown in FIG. 6C, actions including conditional actions may also be identified by a user. In step 640, a user identifies an action. An action for example may be an event a user wishes to add to an application being developed. A user for example may select an action from control window 702 or from model display elements presented in canvas 704.

In step 642, editor 110 initializes an Action Model. An action model may be initialized automatically by editor 110 or in response to a user input.

In step 644, editor 110 may output a model display element for an action identified in step 642. The model display element may have one or more selectable action components that correspond to the identified action. For example, an action model display element 766 for setting a type of scoring (such as variable) may be displayed in branch 760 in canvas 704. This action can be logically relating to a swipe touch interaction set through model display element 762 (when guitar is swiped) and effect display element 764 (increase score by one when guitar is swiped).

A user may then select action components through the model display element (step 646). Action components may be components relating to an action such as, conditional case, condition, value equation, effect, or animation. For example, model display element 766 when set for variable scoring may include conditional cases (if, then), condition (score greater than a value 10), and reference an effect (play victory music) selectable in an effect model display element 768. Action model for setting a variable (score) may also let a user select properties, types of variables, or operations.

In step 648, editor 110 updates one or more action component models with corresponding selected action components. In step 650, editor 110 inserts new action components selected into an initialized action model.

In step 652, editor 110 may also enable a user to create one or more variable models for a project. A variable model may be initialized automatically by editor 110 or in response to a user input.

In this way, through the operation of step 608 (including steps 622-652), editor 110 allows a user to define a project with interactions, effects and actions represented by models in a nested model hierarchy. An editor 110 stores project logic made up of nested models that identify a story as described with respect to FIG. 2. In particular, step 608 (including steps 622-652) and step 610 as described herein allow a variety of models (Scene, Layer, Interaction, Action, Effect, Conditional Case, Condition, Reference, Animation Component, Variable, Value, and Value Equation) to be created and stored in a nested model hierarchy. These steps do not have to necessarily be carried out in order and can be repeated and carried out separately depending a user's particular development choices. In step 608 (including steps 622-652) different models can be created at different times and in a different order as would be apparent to person skilled in the art given this description. Indeed a user often selects and creates different models at different times as they develop an application.

Preview

In a further feature, previewing capability that shows the runtime operation of the project is provided. As a project develops, the project logic created may be previewed by a user. The preview allows a user to see and interact with the project as in runtime without having to compile code. The preview may be generated as shown in Scene Events window 706 as a user creates models. In another example, a preview may be generated in a separate window on the same or different device independent of the project logic creation or editing of the project.

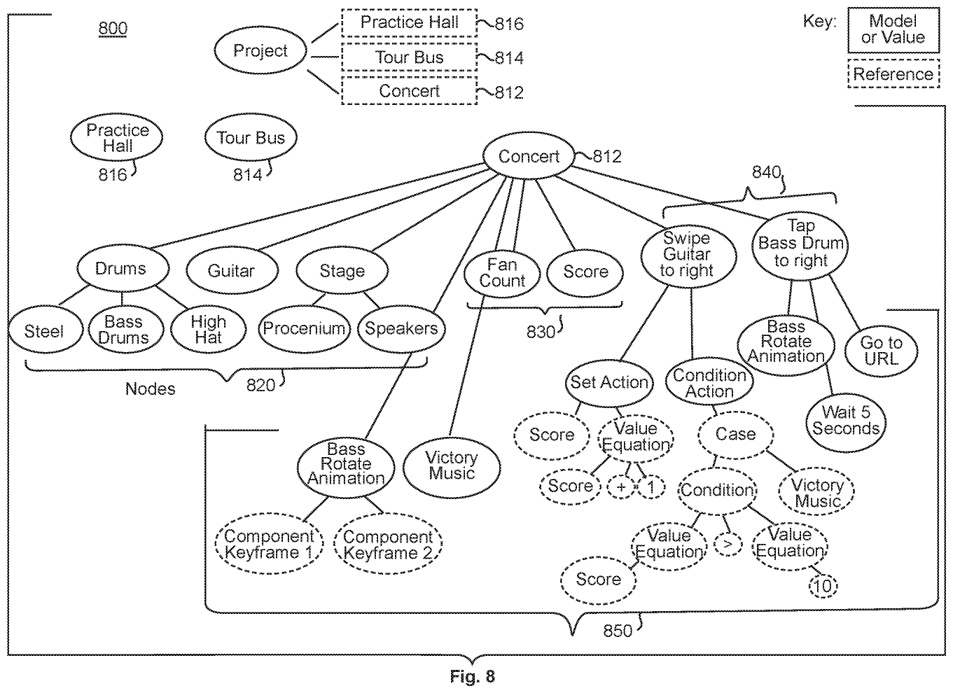

As shown in FIG. 6D, in step 660 a loading context may be generated for a preview from stored project logic. The generated loading context includes runtime objects and any corresponding media assets based on the stored project logic. In particular, the runtime objects and any corresponding media assets are generated based on the nested models in a hierarchy for the stored project logic. In step 670, the generated loading context is saved locally or remotely in a computer-readable memory. In an embodiment, previewer 120 can carry out steps 660-670 on computing device 100. The generated loading context may be saved in computer-readable memory 170. This storing can be local in a cache or other system memory, or remotely over a computer network through network interface 180. The operation of previewer 120 and previewing is described further below with respect to FIGS. 8-10.

FIG. 8 is a diagram of example project logic 800 for a story defined with a nested model hierarchy in accordance with an embodiment. Project logic 800 may be created and stored using application tool 105 and editor 110 as described above and with respect to the method of FIG. 6. Project logic 800 may cover a story having three scenes involving a concert, tour bus, and practice hall. References 812, 814 and 816 to these respective scenes are included in project logic 800. These references identify respective scene models relating to the scenes. As shown in FIG. 8, an example scene model 812 is provided for the concert scene. This scene can be the two figure drum and guitar scene described with respect to FIG. 7. Scene model 812 is part of a nested model hierarchy with other models. These other models include layer models (also called nodes when used for runtime objects) 820, variable models 830, interaction models 840, and action models and other models and references 850. Tour bus model 814 may include its own set of nested models in hierarchy for the objects, interactions, effects and actions in that scene. Practice hall model 816 may include its own set of nested models in hierarchy for the objects, interactions, effects and actions in that scene.

FIG. 9 is a diagram illustrating a factory operation to generate a runtime loading context from stored models in accordance with an embodiment. For example, factory 420 operates on models, such as the nested models in hierarchy for the concert scene in stored project logic 800, to generate a loading context 970 (step 910). Loading context 970 includes runtime objects and any corresponding media assets that allow a story represented by the project logic 800 to operate at runtime without compiling code.

In routine 910, a loading context is initialized. In step 912, factory 420 loads a scene model (such as Concert model 800). A check may also be made to see if a template is present (step 914). If found, the template facilities traversal of the model hierarchy and identification of models as the same operations can be repeated recursively on the template.

In step 920, factory 420 creates Value Store runtime objects from Variable models in the project logic 800. A value store runtime object is created for each variable in a scene model.

In step 930, factory 420 creates Node runtime objects from Layer models in the project logic 800. A node runtime object is created for every layer in layer models referenced by a scene model.

In step 940, factory 420 creates Action runtime objects from Action models in the project logic 800. An action runtime object is created for every action model reference by a scene model. A check is made to resolve all layer model references for created action runtime objects with initialized node runtime objects created in step 930.

In an example in step 942, for an Action runtime object created in step 940, control proceeds to create any dynamic equation components that may relate to the action. Resolved references in the reference map are used to identify data in runtime objects to be used in the dynamic equation components (step 962). An Action model may also be logically related to an Effect model and/or an Interaction Model. Accordingly, in step 944, control may also proceed to process an Effect model that may relate to the action. Resolved references in the reference map are used to identify data in runtime objects to be used in components drawn from the Effect model (step 964).

In step 950, factory 420 creates Event Rules runtime objects from Interaction Models in the project logic 800. An event rule runtime object is created for every interaction model referenced in a scene model. This includes event rules reflecting any nested actions and resolving action references so that they refer correctly to action runtime objects. Trigger conditions are determined for the event rule runtime object and references to created node or action runtime objects are resolved.

In an example in step 944, for an Event Rule runtime object created in step 950 from an Interaction model, control proceeds to process an Effect model that may relate to the interaction. Resolved references in the reference map are used identify data in runtime objects to be used in components drawn from the Effect model (step 966).

Factory 420 essentially traverses the model hierarchy loaded with a scene and carries out steps 920-950 for each respective models. For models like those in steps 930, 940, 950 which may have children models in the hierarchy, factory 420 traverses branches of the hierarchy and carried out steps 930-950 for respective child models as well. As shown in step 960, checks of a reference map are made throughout or after steps 920-950. The reference map lists a temporal sequence of the runtime objects and any corresponding media assets. Checks are made in step 960 to see if a created runtime object is new and whether a reference to the runtime object needs to be added to a reference map. Check is also made to see if the runtime object being assessed conflicts with a runtime sequence of other references to runtime objects. If there is a conflict, then the conflict is resolved and the references are resolved in the reference map to add a reference to the created runtime object to the reference map. The new runtime object is added to the reference map is a correct sequence of runtime objects created in steps 920-950 for the loaded scene in step 912.

In routine 910, steps 912-960 continue recursively until all models in a scene have been processed. This can continue in a lazy or greedy pattern until all scenes in a story have been loaded from project logic 800 and processed to obtain runtime objects and corresponding media assets in a loading context 970. Loading context 970 can be output for storage in memory 170 including a cache or other local memory, and/or in a remote memory storage device.

Previewer 120 can access the output loading context 970 and process the runtime objects and any corresponding media assets for display to a user. In this way, the user can experience a project as it would appear in runtime. This includes viewing and interacting with objects in scenes of a story as a user would in runtime. For example, canvas controller 430 can be used to access and process the runtime objects and corresponding media assets in loading context 970 and provide pageable content to a display area such as a canvas (e.g., scene events window 704 or other display window). Renderer 490 can then render for display the content.

Canvas controller 430 may directly access value store runtime objects 450. Canvas controller 430 may coordinate with factory 420 to access node runtime objects 462 created by factory 420. Canvas controller 430 controls the life-cycle for node runtime objects. Action manager 470 controls the life-cycle for runtime action objects 472. Event mapper 480 organizes event rule runtime objects in an optimized fashion 482 including nested action runtime objects 484. Canvas controller 430 may coordinate with action manager 470 and event mapper 480 to initiate creation of and access respective runtime objects and media assets for a preview.

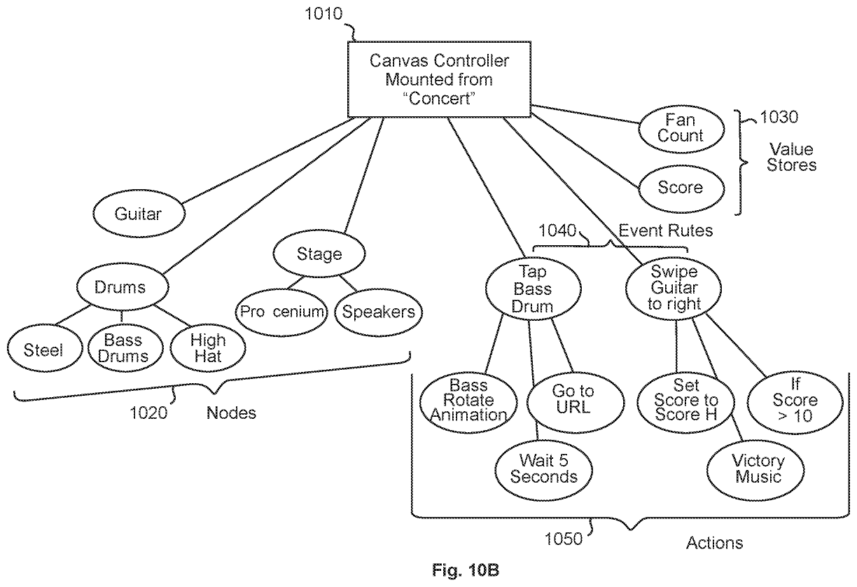

FIG. 10A shows an example and logical representation of how a canvas controller 430 may access node runtime objects 1020, value store runtime objects 1030 and event rule runtime objects 1040 including nested action runtime objects 1050.

FIG. 10B is a diagram that shows an example canvas controller 1010 mounted from the Concert loading context example in FIG. 8. In this case, canvas controller 1010 may access node runtime objects 1020, value store runtime objects 1030 and event rule runtime objects 1040 including nested action runtime objects 1050. Node runtime objects 1020 correspond to objects in the scene, namely, guitar, drums, stage, stool bass drum, high hat, speakers and proscenium. Value store runtime objects 1030 correspond to a fan count and score. Event rule runtime objects 1040 correspond to tap bass drum and swipe guitar interactions. Action runtime objects 1050, including nested action runtime objects, correspond to actions, conditions, and values including bass drum rotation animation, wait 5 seconds, go to URL for the bass drum interaction; and set score to high score and if score is greater than 10, play victory music for the swipe guitar interaction.

Publish

In a further feature, publication to an application store ready code or preview readable application project can be performed. In step 680, an export to application store ready code is performed. A user for example, can select Publish from a tab or other user-interface control. A user may also identify or select a project to be published on an application store. Publisher 130 then will initiate an export operation to convert the stored project logic for the project into application store ready code without a user having to write programming code or transfer the data containing archived models to any device containing the preview components without compiling code.

An example of a routine for carrying out step 680 is shown in further detail in FIG. 11. FIG. 11 is a flowchart diagram of a publishing operation to publish application store ready code in accordance with an embodiment (steps 1110-1150). First, publisher 130 may display a prompt for content to a user (step 1110). For example, publisher 130 may prompt a user to enter a project name to be published. Publisher 130 then copies a draft of the project (essentially a shell for the project) into a location in memory (step 1120). Publisher 130 copies model data from stored project logic into the draft at the memory location (step 1130). Publisher 130 also copies any media assets referenced in the models into the location (step 1140). Publisher 130 then modifies an information property list file (info p list) to the project name and bundle ID (step 1150). For example, the bundle ID may be a unique IP for the application store.

### Further Embodiments and Example Implementations

Aspects of the embodiments for exemplary application tool 105 (including editor 110, previewer 120, publisher 130 and project logic processor 140 and components therein) may be implemented electronically using hardware, software modules, firmware, tangible computer readable or computer usable storage media having instructions stored thereon, or a combination thereof and may be implemented in one or more computer systems or other processing systems.

Embodiments may be directed to computer products comprising software stored on any computer usable medium such as memory. Such software, when executed in one or more data processing device, causes a data processing device(s) to operate as described herein.

Various embodiments can be implemented, for example, using one or more computing devices. A computing device (such as device 100) can be any type of device having one or more processors and memory. For example, a computing device can be a workstation, mobile device (e.g., a mobile phone, personal digital assistant, tablet or laptop), computer, server, computer cluster, server farm, game console, set-top box, kiosk, embedded system, or other device having at least one processor and memory.

FIG. 5 shows an example computing device 500 that may be used as computing device 100 to implement application tool 105. Computing device 500 can be any well-known computer capable of performing the functions described herein, such as computers available from Apple, Google, HP, Dell, Sony, Samsung, Toshiba, etc.

Computing device 500 includes one or more processors (also called central processing units, or CPUs), such as a processor 510. Processor 510 is connected to a communication infrastructure 520 (e.g., a bus).

Computing device 500 also includes user input/output device(s) 590, such as monitors, keyboards, pointing devices, microphone for capturing voice input, touchscreen for capturing touch input, etc., which communicate with communication infrastructure 520 through or as part of user input/output interface(s).

Computing device 500 also includes a main or primary memory 530, such as random access memory (RAM). Main memory 530 may include one or more levels of cache. Main memory 530 has stored therein control logic (i.e., computer software) and/or data.

Computing device 500 may also include one or more secondary storage devices or memory 540. Secondary memory 540 may include, for example, a hard disk drive 550 and/or a removable storage device or drive 560. Removable storage drive 560 may be a floppy disk drive, a magnetic tape drive, a compact disk drive, an optical storage device, tape backup device, and/or any other storage device/drive.

Removable storage drive 560 may interact with a removable storage unit 570. Removable storage unit 570 includes a computer usable or readable storage device having stored thereon computer software (control logic) and/or data. Removable storage unit 570 may be a floppy disk, magnetic tape, compact disk, DVD, optical storage disk, and/any other computer data storage device. Removable storage drive 560 reads from and/or writes to removable storage unit 570 in a well-known manner.

According to an exemplary embodiment, secondary memory 540 may include other means, instrumentalities or other approaches for allowing computer programs and/or other instructions and/or data to be accessed by computing device 500. Such means, instrumentalities or other approaches may include, for example, a removable storage unit 570 and an interface. Examples of the removable storage unit 560 and the interface may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Memory controller 575 may also be provided for controlling access to main memory 530 or secondary memory 540. This may include read, write, or other data operations.

Computing device 500 may further include a communication or network interface 580. Communication interface 580 enables computing device 500 to communicate and interact with any combination of remote devices, remote networks, remote entities, etc. For example, communication interface 580 may allow computing device 500 to communicate with remote devices over communications path 585, which may be wired and/or wireless, and which may include any combination of LANs, WANs, the Internet, etc. Control logic and/or data may be transmitted to and from computing device 500 via communication path 585.

In an embodiment, a tangible apparatus or article of manufacture comprising a tangible computer useable or readable medium having control logic (software) stored thereon is also referred to herein as a computer program product or program storage device. This includes, but is not limited to, computing device 500, main memory 530, secondary memory 540, and removable storage unit 570, as well as tangible articles of manufacture embodying any combination of the foregoing. Such control logic, when executed by one or more data processing devices (such as computing device 500), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 5. In particular, embodiments may operate with software, hardware, and/or operating system implementations other than those described herein.

The Brief Summary and Abstract sections may set forth one or more but not all exemplary embodiments of the present invention as contemplated by the inventor(s), and thus, are not intended to necessarily limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The breadth and scope of the present invention should not be limited by any of the above-described exemplary embodiments.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A system comprising:
an application tool configured to enable a user to compose project logic for an application through a user-interface; and
memory that can store the project logic, wherein the application tool is configured to output for display one or more user-interface elements that enable a user to identify conditional logic and parameters for events that compose the project logic, whereby a user can create the application solely through the user-interface without having to write program code.

2. The system of claim 1, wherein the application includes interactive media and the one or more user-interface elements enable a user to identify conditional logic and parameters for events that involve the interactive media.

3. The system of claim 2, wherein the parameters for events include trigger parameters that define state information and effects for one or more events, the state information including the requisite states indicative of when a response for particular event is to be triggered at runtime of the application, and the effects being information that identifies operations or instructions to be performed for the particular event during runtime of the application.

4. The system of claim 3, wherein at least one effect comprises a reference to a separately defined action or comprises one or more values that define an action to be carried out during runtime of the application.

5. The system of claim 2, wherein the stored project logic includes a plurality of nested models that define one or more scenes of interactive media content in the application.

6. The system of claim 5, wherein the nested models include a set of default models modified to define the one or more scenes of interactive media content in the application.

7. The system of claim 5, wherein each scene model includes a reference to one or more of the following models: Layer, Interaction, Action, Effect, Conditional Case, Condition, Reference, Animation Component, Variable, Value, or Value Equation.

8. The system of claim 1, wherein the stored project logic comprises a plurality of nested models, each nested model being a self-archiving model.

9. The system of claim 8, wherein each self-archiving model identifies its own respective archiving and unarchiving characteristic.

10. The system of claim 1, wherein the application tool comprises an editor configured to control edits to the project logic composed for the application.

11. The system of claim 10, wherein the editor is configured to output an editor window for display, the editor window including at least one of a control region, canvas region, or scene events region.

12. The system of claim 10, wherein the one or more user-interface elements comprise model display elements, and the editor is configured to output an editor window for display, the editor window including a control region and a canvas region; and
wherein the control region includes a user-interface control element displayed in the control region of the editor that enables a user to identify an interaction for an event in the application, and the editor is configured to initialize an interaction model corresponding to the identified interaction and output for display in the canvas region one or more model display elements having one or more selectable triggers for the identified interaction;
whereby a user developing an application can add the interaction to a workflow of the application through selections made in the canvas region with respect to the one or more model display elements without having to write program code.

13. The system of claim 12, wherein the editor is configured to update the interaction model to represent selected triggers for the identified interaction.

14. The system of claim 13, wherein the identified interaction includes one or more effects that may be conditionally associated with the identified interaction, and wherein the editor is configured to output for display in the canvas region one or more model display elements having one or more selectable parameters for an effect for the identified interaction; whereby a user developing an application can add an effect to an interaction in a workflow of the application through selections made in the canvas region with respect to the one or more model display elements without having to write program code.

15. The system of claim 14, wherein the editor is configured to update an effect model to represent a selected parameter for an effect conditionally associated with the identified interaction, and update the interaction model to represent the selected effect.

16. The system of claim 1, wherein the application tool comprises a previewer configured to process the project logic composed for an application to obtain runtime objects including references to media assets that enable a user to view and interact with the application in runtime; and a publisher configured to automatically publish application store ready code based on the stored project logic composed for an application.

17. The system of claim 2, wherein the stored project logic includes model data and assets of the interactive media which can be transferred between one or more applications and/or storage devices without the need to compile code.

18. A computer-implemented method comprising:
enabling a user to compose project logic for an application through a user-interface including displaying one or more user-interface elements that enable a user to identify conditional logic and parameters for events that compose the project logic; and
storing the project logic in computer-readable memory, whereby a user can create an application solely through the user-interface without having to write program code.

19. The method of claim 18, wherein the enabling a user to compose project logic includes:
enabling a user to identify an interaction for an event in the application;
initializing an interaction model corresponding to the identified interaction;
outputting for display in a canvas region of an editor window one or more model display elements having one or more selectable triggers for the identified interaction;
updating the interaction model to represent selected triggers for the identified interaction, wherein the identified interaction includes one or more effects that may be conditionally associated with the identified interaction;
outputting for display in the canvas region one or more model display elements having one or more selectable parameters for an effect for the identified interaction;
updating an effect model to represent a selected parameter for an effect conditionally associated with the identified interaction; and
updating the interaction model to represent the selected effect, whereby a user creating an application can add an effect to an interaction in a workflow of the application through selections made in the canvas region with respect to the one or more model display elements without having to write program code.

20. A non-transitory computer-readable storage device having instructions stored thereon that, when executed by at least one processor, causes the at least one processor to perform operations for developing an application, wherein the operations comprise:
enabling a user to compose project logic for an application through a user-interface including displaying one or more user-interface elements that enable a user to identify conditional logic and parameters for events that compose the project logic; and
storing the project logic in computer-readable memory, whereby a user can create an application solely through the user-interface without having to write program code.
